(19) United States
(12) Patent Application Publication
(10) Pub. No.: US 2018/0159920 A1
(43) Pub. Date: Jun. 7, 2018

(54) SERVER LOAD BALANCING METHOD, APPARATUS, AND SERVER DEVICE

(71) Applicant: ALIBABA GROUP HOLDING LIMITED, George Town (KY)

(72) Inventors: Aren YAN, Hangzhou (CN); Jin WEI, Beijing (CN); Xiaochen WANG, Hangzhou (CN)

(73) Assignee: ALIBABA GROUP HOLDING LIMITED

(21) Appl. No.: 15/831,286

(22) Filed: Dec. 4, 2017

(30) Foreign Application Priority Data
Dec. 7, 2016 (CN) 201611117522.5

(51) Int. Cl. H04L 29/08; H04L 12/803; H04L 12/725

(52) U.S. Cl. CPC H04L 67/101; H04L 67/1008; H04L 45/302; H04L 67/1012; H04L 47/125; H04L 67/1017

(57) ABSTRACT

The present application discloses a server load balancing method and apparatus, and a server device. The method includes: classifying, according to link quality of back-end servers in a server cluster, the back-end servers into multiple server groups; setting priorities of the multiple server groups according to link quality of the server groups; selecting, when an access request sent by a first terminal is received, a server group from the multiple server groups as a target server group based on the priorities; selecting a target back-end server from the target server group; and establishing communication between the target back-end server and the first terminal. When selecting a target back-end server that establishes communication with a user terminal, the implementation further takes the issue of the link quality of the back-end server into account, which avoids the problem of a relatively long communication response time caused by relatively poor link quality of the target back-end server, thus improving the efficiency of communication and the quality of communication between the user terminal and the server cluster.

### CROSS REFERENCE TO RELATED APPLICATION

This application claims priority to Chinese Application No. 201611117522.5, filed on Dec. 7, 2016, the entirety of which is incorporated herein by reference.

### TECHNICAL FIELD

The present application relates to the field of Internet technologies, and more particularly, to a server load balancing method and apparatus, and a server device.

### BACKGROUND

When a user terminal sends an access request to a server cluster, a distribution server in the server cluster may select a back-end server from the server cluster by using a predetermined strategy algorithm and control the selected back-end server to establish a communication connection with the user terminal. Generally, to establish a communication connection with the user terminal, the distribution server can directly select a back-end server from the server cluster by using an IP address hashing algorithm or a round-robin scheduling algorithm. However, the link quality of the back-end server is neglected in the foregoing method. Accordingly, a back-end server with a relatively poor link quality can be selected to establish a connection and interact with the user terminal. If the link quality of the selected back-end server is relatively poor, after the back-end server establishes a communication connection with the user terminal, a communication response time of the back-end server may be relatively long, thus decreasing the efficiency of communication and the quality of communication between the user terminal and the server cluster.

### SUMMARY OF INVENTION

In order to solve the foregoing technical problem, the present application provides a server load balancing method, apparatus, and a server device.

In some embodiments of the present disclosure, a server device is disclosed, comprising a central processing unit, a strategy selection unit, a receiver, and a communication unit. The central processing unit is configured to classify the back-end servers into multiple server groups according to link quality of back-end servers in a server cluster, and set priorities of the multiple server groups according to link quality of the server groups. The receiver is configured to receive an access request sent by a first terminal. The strategy selection unit is configured to select, when the receiver receives the access request sent by the first terminal, a server group from the multiple server groups as a target server group based on the priorities, and select a target back-end server from the target server group. The communication unit is configured to establish communication between the target back-end server and the first terminal based on the selection of the strategy selection unit.

In some embodiments, a server load balancing method is disclosed. The server load balancing method comprises classifying the back-end servers into multiple server groups according to link quality of back-end servers in a server cluster, setting priorities of the multiple server groups according to link quality of the server groups, selecting a server group from the multiple server groups as a target server group based on the priorities when an access request sent by a first terminal is received, selecting a target back-end server from the target server group, and establishing communication between the target back-end server and the first terminal.

In some embodiments, a server load balancing apparatus is disclosed. The server load balancing apparatus comprises a grouping unit configured to classify the back-end servers into multiple server groups according to link quality of back-end servers in a server cluster, a setting unit configured to set priorities of the multiple server groups according to link quality of the server groups, a first selection unit configured to select a server group from the multiple server groups as a target server group based on the priorities when an access request sent by a first terminal is received, a second selection unit configured to select a target back-end server from the target server group, and an establishment unit configured to establish communication between the target back-end server and the first terminal.

Embodiments of the present disclosure of method, apparatus, and server device classify the back-end servers into multiple server groups according to link quality of back-end servers in a server cluster, and set priorities of the multiple server groups according to link quality of the server groups. When an access request sent by a user terminal is received, a server group is selected from the multiple server groups as a target server group based on the priorities, and a target back-end server is selected from the target server group to establish communication with the user terminal.

Therefore, the link quality of the back-end server is taken into account when a target back-end server that establishes communication with the user terminal is selected. A target back-end server that establishes communication with the user terminal with better link quality is selected from back-end servers. The disclosed embodiments avoid the problem of a relatively long communication response time caused by relatively poor link quality of the target back-end server, shorten the communication response time, and therefore improve the efficiency of communication and the quality of communication between the user terminal and the server cluster ultimately.

It is to be understood that both the foregoing general description and the following detailed description are exemplary and explanatory only and are not restrictive of the disclosed embodiments.

### BRIEF DESCRIPTION OF THE DRAWINGS

FIG. 1 is a schematic diagram illustrating an exemplary system structure, consistent with embodiments of the present disclosure.

FIG. 2 is a flowchart illustrating an exemplary server load balancing method, consistent with embodiments of the present disclosure.

FIG. 3 is a flowchart illustrating an exemplary method for server load balancing, consistent with embodiments of the present disclosure.

FIG. 4 is a diagram illustrating an exemplary server load balancing apparatus, consistent with embodiments of the present disclosure.

FIG. 5 is a block diagram illustrating an exemplary server load balancing apparatus, consistent with embodiments of the present disclosure.

FIG. 6 is a block diagram illustrating an exemplary server device, consistent with embodiments of the present disclosure.

### DETAILED DESCRIPTION

Exemplary embodiments will be described in detail herein, and examples thereof are shown in the accompanying drawings. In the following description related to the accompanying drawings, the same numerals in different accompanying drawings denote the same or similar elements, unless otherwise specified. Implementations described in the following exemplary embodiments do not represent all implementations consistent with the present application. In contrast, they are merely examples of apparatuses and methods consistent with some aspects of the present application as described in detail in the appended claims.

Terms used in the present application are merely for the purpose of describing specific embodiments, rather than limiting the present application. Singular forms “a(n),” “said,” and “the” used in the present application and the appended claims also include plural forms, unless clearly specified in the context that they denote other meanings. It should be further understood that the term “and/or” used herein refers to and includes any or all possible combinations of one or more associated items listed.

It is to be understood that, although terms such as “first,” “second,” and “third” may be used to describe various kinds of information in the present application, these kinds of information should not be limited to these terms. These terms are merely used to distinguish information of the same type from each other. For example, without departing from the scope of the present application, first information may also be referred to as second information, and similarly, second information may also be referred to as first information. Depending on the context, the word “if” used herein may be explained as “when . . . ”, “as . . . ”, or “in response to the determination”.

Reference is now made to FIG. 1, which illustrates an exemplary system structure, consistent with embodiments of the present disclosure. As shown in FIG. 1, a system architecture 100 may include user terminal devices 101 and 102, a network 103, and a server cluster 104, wherein server cluster 104 may include at least one distribution server 105, and multiple back-end servers 106, 107, 108, and 109.

Network 103 is configured to provide a communication link medium between cluster server 104 and user terminal devices 101 and 102. Network 103 may include various connection types, for example, a wired or wireless communication link or an optical fiber cable, and so on.

User terminal devices 101 and 102 can be configured to interact with server cluster 104 via network 103, to receive or send a request or information. User terminal devices 101 and 102 are electronic devices, which can be, but are not limited to, smart phones, tablet computers, portable laptop computers, desktop computers, smart watches, and so on. Server cluster 104 can be a server cluster that provides various services, and provide a service in response to a service request of a user. Distribution server 105 can be configured to select, when receiving an access request from user terminal device 101 or 102, a target back-end server from back-end servers 106, 107, 108, and 109 by using a predetermined selection strategy, and control the target back-end server to establish communication with user terminal device 101 or 102 for interaction.

It is to be understood that the number of user terminal devices, the number of networks, the number of distribution servers and the number of back-end servers in FIG. 1 are merely illustrative. According to implementation requirements, there may be any number of user terminal devices, any number of networks, any number of distribution servers, and any number of back-end servers.

Based on the system architecture illustrated in FIG. 1, in some embodiments, user terminal device 101 or 102 can interact with server cluster 104 via network 103, to receive or send information and the like. For example, user terminal device 101 or 102 may send an access request to server cluster 104 via network 103, and distribution server 105 in cluster server 104 receives the access request. Distribution server 105, in response to the access request, selects a target back-end server from back-end servers 106, 107, 108, and 109 by using a predetermined selection strategy, then acquires an address of the target back-end server as a target address, and forwards the access request to the target back-end server according to the target address. The target back-end server sends response information to distribution server 105, which sends the response information to user terminal device 101 or 102 via network 103, thus accomplishing an interaction between user terminal device 101 or 102 and server cluster 104.

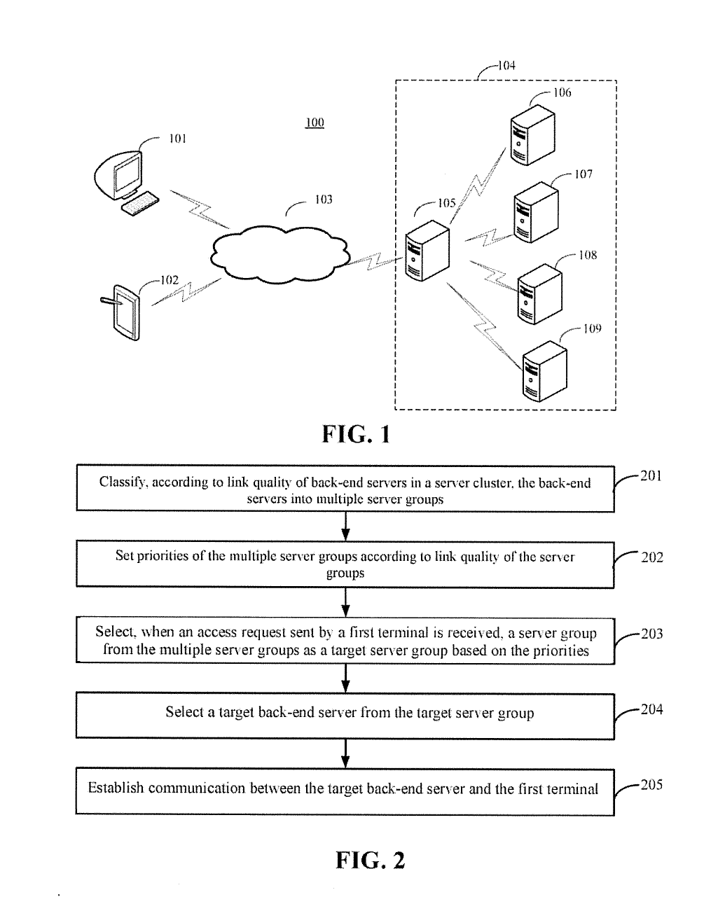

Reference is now made to FIG. 2, which is a flowchart of an exemplary server load balancing method, consistent with embodiments of the present disclosure. The embodiment can be applied to a distribution server (e.g., distribution server 105 of FIG. 1), and the method comprises the following steps.

In step 201, according to link quality of back-end servers in a server cluster, the back-end servers are classified into multiple server groups.

Generally, the link quality can reflect the quality of a communication link. The link quality is related to communication speed, achievable rate (e.g., 1−packet loss rate=achievable rate), jitter and other issues. The link quality can be represented and measured by using a parameter related to the communication speed, the achievable rate, etc. The back-end servers can be classified into any multiple server groups according to link quality of back-end servers in a server cluster. It is to be understood that the present application does not limit the number of server groups obtained by classification. In the server cluster, a server that provides service data to an end user and undertakes a service function is referred to as a back-end server. The back-end server can communicate and interact with the user terminal.

In some embodiments, a link quality parameter of the server cluster in a preset period can be acquired as a reference parameter. The link quality parameter of each back-end server in the server cluster in the preset period can be acquired respectively. Back-end servers having link quality parameter greater than or equal to the reference parameter are classified into a first priority group, and back-end servers having link quality parameter less than the reference parameter are classified into a second priority group. It is appreciated that the back-end servers having link quality parameter less than the reference parameter may also be classified into multiple groups. For example, the back-end servers having link quality parameters less than the reference parameter may be further classified into a second priority group and a third priority group according to values of the link quality parameters. The back-end servers having link quality parameters less than the reference parameter may be classified into multiple groups in any reasonable manner, which is not limited in the present application. The link quality parameter may be any parameter capable of representing link quality, for example, parameters related to a data transmission speed, an achievable rate, link jitter and so on, and may also be a parameter that is obtained by performing weighting processing on these parameters and comprehensively reflects the foregoing link quality. It is to be understood that the link quality parameter may also be another parameter, which is not limited in the present application.

For example, data transmission speed can be used as link quality parameter. The link quality parameter of the server cluster in a preset period may be obtained by dividing the total volume of data transmitted by the server cluster in the preset period by the time of the preset period, and the link quality parameter can be used as a reference parameter. For each back-end server in the cluster server, the link quality parameter of the back-end server in the preset period may be obtained by dividing the volume of data transmitted by the back-end server in the preset period by the time of the preset period. Back-end servers having data transmission speeds greater than or equal to the reference parameter are classified into a first priority group, and the remaining back-end servers are classified into another one or more priority groups. Thus it is known that the link quality of the back-end servers having data transmission speed greater than or equal to the reference parameter is better than the link quality of another one or more back-end server groups.

For another example, an achievable rate can be used as the link quality parameter. The link quality parameter of the server cluster in a preset period can be a total achievable rate of the server cluster in the preset period, and the link quality parameter can be used as a reference parameter. For each back-end server in the cluster server, a link quality parameter of the back-end server in the preset period can be an achievable rate of the back-end server in the preset period. Back-end servers having achievable rates greater than or equal to the reference parameter are classified into a first priority group, and the remaining back-end servers are classified into another one or more priority groups. Thus it is known that the link quality of the back-end servers having achievable rates greater than or equal to the reference parameter is better than the link quality of another one or more back-end server groups.

In some embodiments, link quality parameter of each back-end server in the server cluster in a preset period can be acquired respectively. Back-end servers having link quality parameter greater than or equal to a predetermined threshold are classified into a first priority group, and back-end servers having link quality parameter less than the predetermined threshold are classified into another one or more priority groups. The predetermined threshold may be a preset parameter acquired from pre-stored data, which is a preset value. The present application does not limit the specific value of the predetermined threshold.

In some embodiments, the preset period is a preset time period. For example, the distribution server can group the back-end servers at intervals of a preset period (with a preset cycle). The preset period may be one cycle or N cycles (N is a natural number, N>1). For another example, the step of classifying the back-end servers into multiple server groups according to link quality of back-end servers in a server cluster can further comprise a step of establishing communication between the back-end servers in the server cluster and a second terminal that sends an access request by means of roll polling. In this case, the preset period is the period of roll polling. Specifically, before the back-end servers are grouped, when an access request from a user terminal (the second terminal) is received, it is possible to establish communication between each back-end server with multiple second terminals that send access requests by means of roll polling. After one round of roll polling, the period of roll polling is the preset period, and link quality parameter of the server cluster in the period of roll polling and link quality parameters of the back-end servers can be acquired, and the back-end servers are grouped based on the parameters.

In step 202, priorities of the multiple server groups are set according to link qualities of the server groups.

In some embodiments, priorities of the multiple server groups may be set according to link quality of the server groups, wherein a descending order of the priorities of the server groups is consistent with a descending order of the link quality of the server groups. That is, the higher the link quality of a server group is, the higher the priority of the server group is. For example, data transmission speeds of back-end servers in a server group A are all greater than or equal to a, and data transmission speeds of back-end servers in a server group B are all less than a. Therefore, the link quality of the server group A can be higher than that of the server group B. In this case, the priority of the server group A is higher than that of the server group B.

In step 203, a server group from the multiple server groups is selected as a target server group based on the priorities when an access request sent by a first terminal is received.

In step 204, a target back-end server is selected from the target server group.

In some embodiments, when an access request sent by a first terminal is received, a server group with the highest priority may be selected from one or more alternative server groups in the multiple server groups as the target server group. The alternative server groups are server groups that include back-end servers in an available state. Then, a back-end server in an available state is selected from the target server group as the target back-end server by using a predetermined algorithm. For example, the priority of the server group A is higher than that of the server group B. When an access request sent by a first terminal is received, the server group A is first tried to select a target back-end server. If all servers in the group A are not in an available state, a target back-end server is selected from the server group B whose priority is one level lower.

In some embodiments, the predetermined algorithm can comprise a weighted round-robin scheduling algorithm. It is appreciated that the predetermined algorithm may also include any other reasonable algorithms, and the present application does not limit the specific type of the predetermined algorithm.

In step 205, communication is established between the target back-end server and the first terminal.

In some embodiments, the back-end servers are classified into multiple server groups according to link quality of back-end servers in a server cluster. Priorities of the multiple server groups are set according to link quality of the server groups. When an access request sent by a user terminal is received, a server group is selected from the multiple server groups as a target server group based on the priorities. A target back-end server is selected from the target server group to establish communication with the user terminal. Therefore, when a target back-end server that establishes communication with the user terminal is selected, the issue of the link quality of the back-end server is further taken into account. A target back-end server that establishes communication with the user terminal is selected from back-end servers with better link quality. This avoids the problem of a relatively long communication response time caused by relatively poor link quality of the target back-end server, shortens the communication response time, and improves the efficiency of communication and the quality of communication between the user terminal and the server cluster.

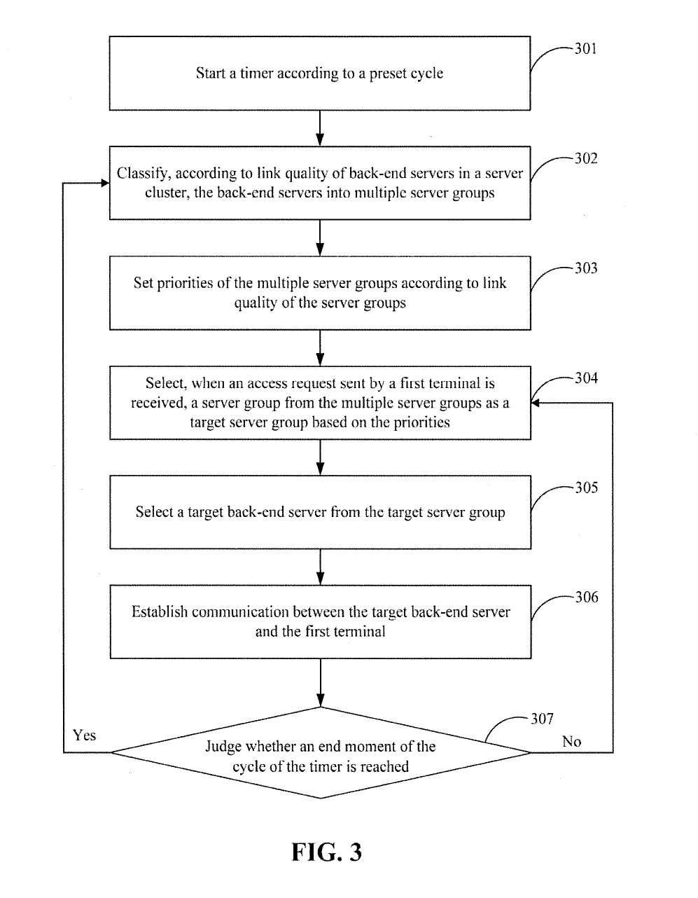

Reference is now made to FIG. 3, which is a flowchart illustrating an exemplary method for server load balancing, consistent with embodiments of the present disclosure. The process of grouping according to a preset cycle is described. This embodiment can be applied to a distribution server. The exemplary method comprises the following steps.

In step 301, a timer is started according to a preset cycle.

In general, the link quality of server can change. Therefore, groupings according to the link quality of the server can be adjusted at intervals of a time period. In some embodiments, a timer can be employed for timing, and when the cycle of the timer ends, the timer can send a trigger signal, to trigger the distribution server to group the back-end servers once more.

The preset cycle can be any reasonable cycle, and the present application does not limit the specific value of the preset cycle.

In step 302, according to link quality of back-end servers in a server cluster, the back-end servers are classified into multiple server groups.

In step 303, priorities of the multiple server groups are set according to link quality of the server groups.

In step 304, a server group from the multiple server groups is selected as a target server group based on the priorities when an access request sent by a first terminal is received.

In step 305, a target back-end server is selected from the target server group.

In step 306, communication is established between the target back-end server and the first terminal.

In step 307, it is determined whether the cycle of the timer is ended. If the cycle of the timer ended, the method is performed again from step 302. In some embodiments, if the cycle of the timer is not yet ended, the method is continued from step 304.

By use of the foregoing embodiment, a timer is started according to a preset cycle. According to link quality of back-end servers in a server cluster, the back-end servers are classified into multiple server groups. Priorities of the multiple server groups are set according to link quality of the server groups. A server group from the multiple server groups is selected as a target server group based on the priorities when an access request sent by a user terminal is received. A target back-end server is selected from the target server group to establish communication with the user terminal. When the cycle of the timer is ended, the step of classifying the back-end servers into multiple server groups is performed again. Therefore, when the target back-end server that establishes communication with the user terminal is selected, the link quality issue of the back-end server is taken into account. Moreover, the issue that the link quality of the server may change is also taken into account. Grouping is performed again at intervals of a time period according to the link quality of the servers, which thus further avoids the problem of a relatively long communication response time caused by a relatively poor link quality of the target back-end server, shortens the communication response time, and improves the efficiency of communication and the quality of communication between the user terminal and the server cluster.

It should be noted that, although the operations of the method according to the embodiments of the present invention are described in a specific order in the accompanying drawings, this does not require or imply that the operations have to be performed according to the specific order, or an expected result can be achieved only by performing all the illustrated operations. On the contrary, the execution order of the steps depicted in the flowchart may be changed. Additionally or alternatively, some steps may be omitted, multiple steps may be combined into one step for execution, and/or one step may be divided into multiple steps for execution.

An application scenario may be a process of establishing a connection between a user terminal A and a back-end server D by a distribution server C in a server cluster B when the user terminal A interacts with the server cluster B.

Specifically, first of all, the distribution server C in the server cluster B starts a timer according to a preset cycle, and communication between each back-end server in the server cluster B and multiple user terminals that send access requests is separately established first by means of roll polling. After one round of roll polling, a link quality parameter m of the server cluster C and a link quality parameter of each back-end server (the greater the link quality parameter is, the higher the link quality is) in a period of roll polling may be acquired. Back-end servers whose link quality parameters are greater than or equal to link quality parameter m may be classified into a group A, back-end servers whose link quality parameters are less than link quality parameter m but greater than link quality parameter n (link quality parameter m is greater than link quality parameter n) are classified into a group B, and back-end servers whose link quality parameters are less than link quality parameter n are classified into a group C′. It is set that priorities in descending order are as follows: the group A, the group B, and the group C′.

Next, when the user terminal A sends an access request to the distribution server C in the server cluster B, back-end servers in the group A can be all in an unavailable state currently, while the group B and the group C′ both include back-end servers in an available state. Then, the group B with the highest priority may be selected from the group B and the group C′ as a target server group. One back-end server D in an available state is selected from the group B by using a predetermined algorithm. The distribution server C may establish communication between the back-end server D and the user terminal A, thus implementing interaction between the back-end server D and the user terminal A.

When the timer starts and the cycle of the timer is ended, the step of establishing communication between each back-end server in the server cluster B and multiple user terminals that send access requests by means of roll polling, and the step of grouping the back-end servers in the server cluster B are performed again.

Accordingly, by use of the foregoing solution, when a back-end server is selected for a user terminal in response to an access request from the user terminal, reference is made to link quality of each back-end server in a server cluster. Hence, a back-end server with relatively good link quality can be selected as much as possible to communicate and interact with the user terminal. This can avoid the problem of a relatively long communication response time caused by a relatively poor link quality of the target back-end server, shorten the communication response time, and improve the efficiency of communication and the quality of communication between the user terminal and the server cluster.

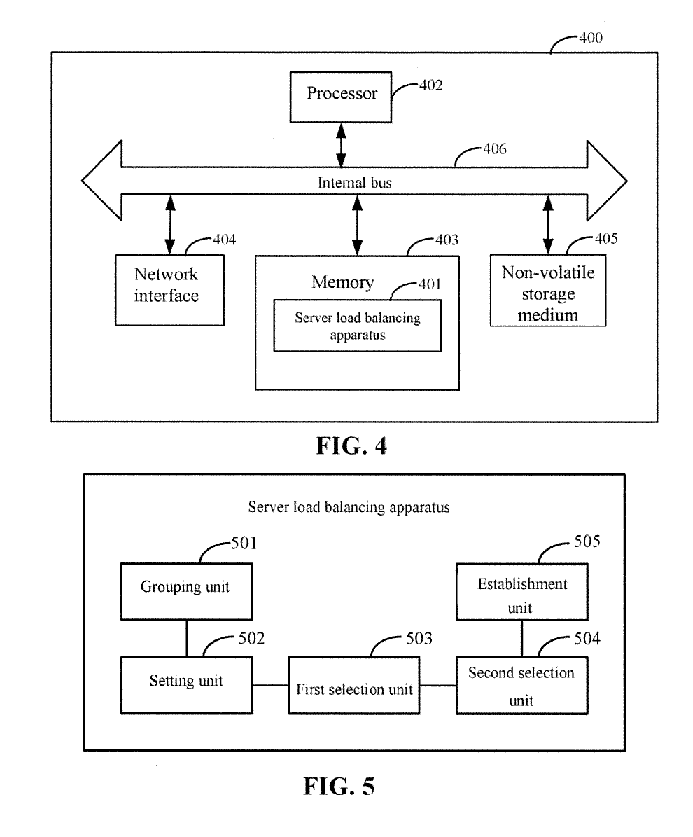

Reference is now made to FIG. 4, which is a diagram illustrating an exemplary server load balancing apparatus, consistent with embodiments of the present disclosure. Corresponding to the embodiment of the server load balancing method according to the present application, the present application further provides embodiments of a server load balancing apparatus and a server device.

The embodiments of the server load balancing apparatus according to the present application may be applied to a server device. The server load balancing apparatus 401 can be implemented using one or more modules/units (and any corresponding sub-modules/sub-units), which can be a packaged functional hardware unit designed for use with other components (e.g., portions of an integrated circuit) and/or a part of a program (stored on a computer readable medium, e.g. a non-volatile storage medium) that performs a particular function of related functions. The one or more modules can have entry and exit points and can be written in a programming language, such as, for example, Java, Lua, C, or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a non-transitory computer readable medium, such as a compact disc, digital video disc, RAM, ROM, flash drive, or any other non-transitory medium, or as a digital download (and can be originally stored in a compressed or installable format that requires installation, decompression, or decryption prior to execution). Such software code can be stored, partially or fully, on a memory device of the executing computing device, for execution by server load balancing apparatus 401. Software instructions can be embedded in firmware, such as an EPROM. It will be further appreciated that hardware modules can be comprised of connected logic units, such as gates and flip-flops, and/or can be comprised of programmable units, such as programmable gate arrays or processors.

In terms of the hardware level, as shown in FIG. 4, a server load balancing apparatus 401 is located in a device 400, the device 400 includes a processor 402, a memory 403, a network interface 404, a non-volatile storage medium 405, and an internal bus 406, wherein processor 402, memory 403, network interface 404, and non-volatile storage medium 405 may communicate with each other via internal bus 406. In addition to processor 402, memory 403, network interface 404, non-volatile storage medium 405, and internal bus 406 shown in FIG. 4, device 400 may further include other hardware according to actual functions of the device, which are not shown one by one in FIG. 4.

Reference is now made to FIG. 5, which is a block diagram illustrating an exemplary server load balancing apparatus, consistent with embodiments of the present disclosure. The apparatus comprises a grouping unit 501, a setting unit 502, a first selection unit 503, a second selection unit 504, and an establishment unit 505. Grouping unit 501 is configured to classify, according to link quality of back-end servers in a server cluster, the back-end servers into multiple server groups. Setting unit 502 is configured to set, according to link quality of the server groups, priorities of the multiple server groups. First selection unit 503 is configured to select, when an access request sent by a first terminal is received, a server group from the multiple server groups as a target server group based on the priorities. Second selection unit 504 is configured to select a target back-end server from the target server group. Establishment unit 505 is configured to establish communication between the target back-end server and the first terminal. In some embodiments, a descending order of the priorities of the server groups is consistent with a descending order of the link quality of the server groups.

In some embodiments, the apparatus may further comprise (not shown in FIG. 5) a timing unit configured to start a timer according to a preset cycle, and a judgment unit configured to determine whether an end moment of the cycle of the timer is reached. If the end moment of the cycle of the timer is reached, the step of classifying the back-end servers into multiple server groups is performed again.

In some embodiments, grouping unit 501 comprises (not shown in FIG. 5) a first acquisition sub-unit, a second acquisition sub-unit, and a first grouping sub-unit. The first acquisition sub-unit is configured to acquire a reference parameter. The second acquisition sub-unit is configured to acquire link quality parameter of each back-end server in the server cluster in a preset period. The first grouping sub-unit is configured to classify back-end servers having link quality parameters that are greater than or equal to the reference parameter into one group, and classify back-end servers having link quality parameters that are less than the reference parameter into one or more groups.

In some embodiments, the first acquisition sub-unit is configured to acquire a link quality parameter of the server cluster in the preset period as the reference parameter. In some embodiments, the first acquisition sub-unit is configured to acquire a preset parameter from pre-stored data as the reference parameter.

In some embodiments, grouping unit 501 may further comprise (not shown in FIG. 5) a roll polling sub-unit configured to establish communication between the back-end servers in the server cluster and a second terminal that sends an access request by means of roll polling, and use a period of roll polling as the preset period.

In some embodiments, first selection unit 503 is configured to select, from one or more alternative server groups in the multiple server groups, a server group with the highest priority as the target server group. The alternative server groups including back-end servers in an available state.

In some embodiments, second selection unit 504 is configured to select, by using a predetermined algorithm, a back-end server in an available state from the target server group as the target back-end server. As an example, the predetermined algorithm comprises a weighted round-robin scheduling algorithm.

For the implementation process of functions and effects of the units in the foregoing apparatus, reference may be specifically made to the implementation process of the corresponding steps in the foregoing method, which are not repeated herein.

It is to be understood that the foregoing apparatus may be preset in a server, or may be loaded into a server by downloading or in other manners. The corresponding modular units in the foregoing apparatus may cooperate with the modular units in the server to implement the solution of server load balancing.

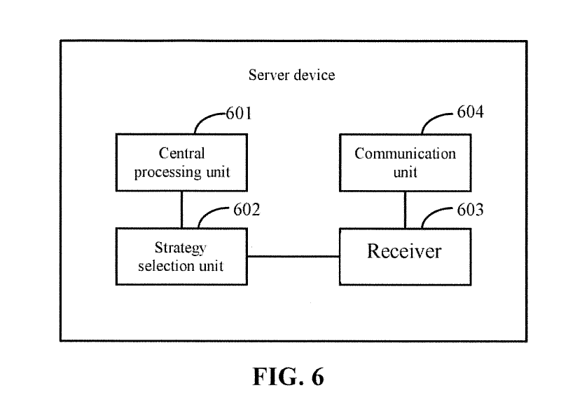

Reference is now made to FIG. 6, which is a block diagram illustrating an exemplary server device, consistent with embodiments of the present disclosure. The server device is applied to a distribution server in a server cluster. The server device comprises a central processing unit 601, a strategy selection unit 602, a receiver 603, and a communication unit 604. Receiver 603 receives an access request sent by a first terminal. When receiver 603 receives the access request sent by the first terminal, strategy selection unit 602 selects a server group from the multiple server groups as a target server group based on the priorities, and selects a target back-end server from the target server group. Communication unit 604 establishes communication between the target back-end server and the first terminal. In some embodiments, a descending order of the priorities of the server groups is consistent with a descending order of the link quality of the server groups.

In some other embodiments, the server device further comprises a timer and a controller (not shown in FIG. 6). The timer is configured to start timing according to a preset cycle. The controller is configured to control, when an end moment of the cycle of the timer is reached, central processing unit 601 to perform the step of classifying the back-end servers into multiple server groups again.

Central processing unit 601 classifies, according to the link quality of back-end servers in a server cluster, the back-end servers into multiple server groups, and sets, according to link quality of the server groups, priorities of the multiple server groups.

In some embodiments, central processing unit 601 is configured to separately acquire a link quality parameter of each back-end server in the server cluster in a preset period and acquire a reference parameter. Central processing unit 601 is also configured to classify back-end servers having link quality parameters that are greater than or equal to the reference parameter into one group, and classify back-end servers having link quality parameters that are less than the reference parameter into one or more groups.

In some embodiments, central processing unit 601 acquires the reference parameter by acquiring a link quality parameter of the server cluster in the preset period as the reference parameter. In some embodiments, central processing unit 601 acquires the reference parameter by acquiring a preset parameter from pre-stored data as the reference parameter.

In some embodiments, central processing unit 601 is further configured to establish, by means of roll polling, communication between the back-end servers in the server cluster and a second terminal that sends an access request. A period of roll polling is used as the preset period.

In some embodiments, strategy selection unit 602 selects a server group from the multiple server groups as a target server group based on the priorities by selecting, from one or more alternative server groups in the multiple server groups, a server group with the highest priority as the target server group. The alternative server groups including back-end servers in an available state.

In some embodiments, strategy selection unit 602 selects a target back-end server from the target server group by selecting, using a predetermined algorithm, a back-end server in an available state from the target server group as the target back-end server. As an example, the predetermined algorithm comprises a weighted round-robin scheduling algorithm.

The apparatus embodiment corresponds to the method embodiment and performs the methods described above. The apparatus embodiment described above is merely schematic, wherein the units described as separate parts may or may not be physically separate, and the parts displayed as units may or may not be physical units, that is, they may be located in one position, or may be distributed on a plurality of network units. Some or all of the modules therein may be selected according to actual needs to achieve the objectives of the solutions of the present application.

After considering the specification and practicing the invention disclosed here, those skilled in the art can easily think of other implementation solutions of the present application. The present application is intended to cover any transformations, uses or adaptive changes of the present application. The transformations, uses or adaptive changes conform to the general principle of the present application and include common general knowledge or conventional technical means in the technical field not disclosed in the present application. The specification and the embodiments are merely regarded as examples, and the real scope and spirit of the present application are indicated by the following claims.

It should be understood that the present application is not limited to the precise structure that has been described above and shown in the accompanying drawings, and various modifications and changes can be made without departing the scope thereof. The scope of the present application is merely limited by the appended claims.

1. A server device, comprising:
a central processing unit configured to classify a plurality of back-end servers into a first plurality of server groups, according to link quality of the plurality of back-end servers in a server cluster, and further configured to set priority of the first plurality of server groups according to link quality of the first plurality of server groups;
a receiver configured to receive an access request sent by a first terminal;
a strategy selection unit configured to select, after the access request is received from the first terminal, a server group from the first plurality of server groups as a target server group based on priority of the first plurality of server groups, and select a target back-end server from the selected target server group; and
a communication unit configured to establish communication between the selected target back-end server and the first terminal based on the selection of the strategy selection unit.

2. The server device of claim 1, wherein the priority of each server group of the first plurality of server groups is ranked in a descending order in accordance with the link quality of each server group of the first plurality of server groups.

3. The server device of claim 1, further comprising:
a timer configured to start counting according to a preset cycle; and
a controller configured to control the central processing unit to classify the plurality of back-end servers into a second plurality of server groups in response to the end of a cycle of the timer.

4. The server device of claim 1, wherein the central processing unit is further configured to:
acquire link quality parameter of each back-end server of the plurality of back-end servers in the server cluster in a preset period;
acquire a reference parameter;
classify one or more back-end servers into a first priority group; and
classify one or more back-end servers into a second priority groups; wherein
a link quality parameter of the one or more back-end servers in the first priority group is greater than the reference parameter; and
a link quality parameter of the one or more back-end servers in the second priority group is less than the reference parameter.

5. The server device of claim 4, wherein the central processing unit is further configured to:
classify one or more back-end servers into a third priority group; wherein a link quality parameter of the one or more back-end servers in the third priority group is less than the reference parameter.

6. The server device of claim 4, wherein the central processing unit is configured to acquire the reference parameter includes the central processing unit being further configured to:
acquire a link quality parameter of the server cluster in the preset period as the reference parameter.

7. The server device of claim 4, wherein the central processing unit is configured to acquire the reference parameter includes the central processing unit being further configured to:
acquire a preset parameter from pre-stored data as the reference parameter.

8. The server device of claim 4, wherein the central processing unit is further configured to:
establish communication between the back-end servers in the server cluster and a second terminal that sends an access request by means of roll polling, wherein the preset period is set as the period of roll polling.

9. The server device of claim 1, wherein the strategy selection unit selects a server group from the plurality of server groups as a target server group based on the priority of the plurality of server groups includes the strategy selection unit being further configured to:
select a server group with the highest priority as the target server group from one or more server groups of the plurality of server groups, wherein the one or more server groups comprising back-end servers in an available state.

10. The server device of claim 1, wherein the strategy selection unit selects a target back-end server from the target server group includes the strategy selection unit being further configured to:
select a back-end server in an available state from the target server group as the target back-end server by using a predetermined algorithm.

11. The server device of claim 10, wherein the predetermined algorithm includes a weighted round-robin scheduling algorithm.

12. A server load balancing method, comprising:
classifying a plurality of back-end servers into a first plurality of server groups according to link quality of the plurality of back-end servers in a server cluster;
setting priority of the first plurality of server groups according to link quality of the first plurality of server groups;
selecting a server group from the first plurality of server groups as a target server group based on the priority of the first plurality of server groups in response to an access request from a first terminal;
selecting a target back-end server from the selected target server group; and
establishing communication between the selected target back-end server and the first terminal.

13. The method of claim 12, wherein the priority of each server group of the first plurality of server groups is ranked in a descending order in accordance with the link quality of each server group of the first plurality of server groups.

14. The method of claim 12, further comprising:
starting a timer according to a preset cycle; and
classifying the plurality of back-end servers into a second plurality of server groups in response to the end of a cycle of the timer.

15. The method of claim 12, wherein the classifying a plurality of back-end servers comprising:
acquiring link quality parameter of each back-end server of the plurality of back-end servers in the server cluster in a preset period;
acquiring a reference parameter;
classifying one or more back-end servers into a first priority group; and
classifying one or more back-end servers into a second priority group; wherein
link quality parameter of the one or more back-end servers in the first priority group is greater than the reference parameter; and
link quality parameter of the one or more back-end servers in the second priority group is less than the reference parameter.

16. The method of claim 15, wherein the classifying a plurality of back-end servers further comprising:
classifying one or more back-end servers into a third priority group; wherein
link quality parameter of the one or more back-end servers in the third priority group is less than the reference parameter.

17. The method of claim 15, wherein the acquiring a reference parameter includes:
acquiring a link quality parameter of the server cluster in the preset period as the reference parameter.

18. The method of claim 15, wherein the acquiring a reference parameter includes:
acquiring a preset parameter from pre-stored data as the reference parameter.

19. The method of claim 15, wherein the classifying one or more back-end servers into a first priority group and a second priority group includes:
establishing communication between the back-end servers in the server cluster and a second terminal that sends an access request by means of roll polling, wherein the preset period is set as the period of roll polling.

20. The method of claim 12, wherein the selecting a server group includes:
selecting a server group with the highest priority as the target server group from one or more server groups of the plurality of server groups, wherein the one or more server groups comprising back-end servers in an available state.

21. The method of claim 12, wherein the selecting a target back-end server includes:
selecting a back-end server in an available state from the target server group as the target back-end server by using a predetermined algorithm.

22. The method of claim 21, wherein the predetermined algorithm comprising: a weighted round-robin scheduling algorithm.

23. A server loading balancing apparatus, comprising:
a grouping unit configured to classify a plurality of back-end servers into a first plurality of server groups, according to link quality of the plurality of back-end servers in a server cluster;
a setting unit configured to set priority of the first plurality of server groups according to link quality of the first plurality of server groups;
a first selection unit configured to select a server group from the first plurality of server groups as a target server group based on priority of the first plurality of server groups in response to an access request from a first terminal;
a second selection unit configured to select a target back-end server from the selected target server group; and
an establishment unit configured to establish communication between the selected target back-end server and the first terminal.

24-33. (canceled)

34. A non-transitory computer readable medium storing a set of instructions that is executable by one or more processors of a server device to cause the server device to perform a method comprising:
classifying a plurality of back-end servers into a first plurality of server groups according to link quality of the plurality of back-end servers in a server cluster;
setting priority of the first plurality of server groups according to link quality of the first plurality of server groups;
selecting a server group from the first plurality of server groups as a target server group based on the priority of the first plurality of server groups in response to an access request from a first terminal;
selecting a target back-end server from the selected target server group; and
providing instructions for establishing communication between the selected target back-end server and the first terminal.

35. The non-transitory computer readable medium of claim 34, wherein the set of instructions that is executable by one or more processors of the controller to cause the controller to further perform:
ranking the first plurality of server groups in a descending order in accordance with the link quality of each server group of the first plurality of server groups.

36. The non-transitory computer readable medium of claim 34, wherein the set of instructions that is executable by one or more processors of the controller to cause the controller to further perform:
starting a timer according to a preset cycle; and
classifying the plurality of back-end servers into a second plurality of server groups in response to the end of a cycle of the timer.

37. The non-transitory computer readable medium of claim 34, wherein the set of instructions that is executable by one or more processors of the controller to cause the controller to classify the plurality of back-end servers comprising:
acquiring link quality parameter of each back-end server of the plurality of back-end servers in the server cluster in a preset period;
acquiring a reference parameter;
classifying one or more back-end servers into a first priority group; and
classifying one or more back-end servers into a second priority group; wherein
link quality parameter of the one or more back-end servers in the first priority group is greater than the reference parameter; and
link quality parameter of the one or more back-end servers in the second priority group is less than the reference parameter.

38. The non-transitory computer readable medium of claim 37, wherein the set of instructions that is executable by one or more processors of the controller to cause the controller to classify the plurality of back-end servers further comprising:
classifying one or more back-end servers into a third priority group; wherein
link quality parameter of the one or more back-end servers in the third priority group is less than the reference parameter.

39. The non-transitory computer readable medium of claim 37, wherein the set of instructions that is executable by one or more processors of the controller to cause the controller to acquire a reference parameter includes:
acquiring a link quality parameter of the server cluster in the preset period as the reference parameter.

40. The non-transitory computer readable medium of claim 37, wherein the set of instructions that is executable by one or more processors of the controller to cause the controller to acquire a reference parameter includes:
acquiring a preset parameter from pre-stored data as the reference parameter.

41. The non-transitory computer readable medium of claim 37, wherein the set of instructions that is executable by one or more processors of the controller to cause the controller to classify one or more back-end servers into a first priority group and a second priority group includes:
establishing communication between the back-end servers in the server cluster and a second terminal that sends an access request by means of roll polling, wherein the preset period is set as the period of roll polling.

42. The non-transitory computer readable medium of claim 34, wherein the set of instructions that is executable by one or more processors of the controller to cause the controller to select a server group includes:
selecting a server group with the highest priority as the target server group from one or more server groups of the plurality of server groups, wherein the one or more server groups comprising back-end servers in an available state.

43. The non-transitory computer readable medium of claim 34, wherein the set of instructions that is executable by one or more processors of the controller to cause the controller to select a target back-end server includes:
selecting a back-end server in an available state from the target server group as the target back-end server by using a predetermined algorithm.

44. The non-transitory computer readable medium of claim 43, wherein the predetermined algorithm comprising: a weighted round-robin scheduling algorithm.
